(19) United States
(12) Patent Application Publication
(10) Pub. No.: US 2007/0080214 A1
(43) Pub. Date: Apr. 12, 2007

(54) METHOD AND SYSTEM FOR MULTI-MEDIA GIFT CARD SYSTEM

(76) Inventors: James P. Collas, San Diego, CA (US); Christos A. Nicolaidis, Carlsbad, CA (US); Daniel E. Shadwell, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/531,134

(22) Filed: Sep. 12, 2006

Related U.S. Application Data
(60) Provisional application No. 60/724,418, filed on Oct. 7, 2005.

(51) Int. Cl. G06K 5/00; G07G 1/14

(52) U.S. Cl. 235/380; 705/14

(57) ABSTRACT

An interactive transaction gift card system containing a code stripe with an identification code which provides the features of a conventional gift card and/or debit card with the added benefits of an interactive multimedia presentation which can be in the form of a virtual store.

### PRIORITY

This application claims the benefit of U.S. Provisional application No. 60/724,418, filed Oct. 7, 2005 and titled Method and System for Multi-Media Gift Card, which is hereby incorporated by reference.

### BACKGROUND

### Field of the Invention

The present invention generally relates to the field of stored value cards or accounts, such as gift cards and Digital Video Disk (DVD) technology, and more particularly relates to an interactive transaction card and the interactive playing of the DVD content stream.

### SUMMARY

The present invention is directed to various aspects of an interactive transaction gift card system and method using an account identifier and a digital media to promote products which can be purchased using the account identifier. An account identifier can represent a pre-paid amount of money that can be redeemed through the account identifier.

In one aspect, the account identifier is contained in a code stripe provides the features of a conventional gift card and/or debit card with the added benefits of an interactive multimedia presentation which can be in the form of a virtual store or catalogue for the products being promoted.

In a further aspect a system and method include showcasing products or services in an interactive, informative and entertaining multi-media format stored on a DVD or other form of a digital data carrier and an account identifier. References to a DVD throughout this application are intended to also refer to other forms of digital data storage including compact discs.

The multi-media interactive show can be used to promote and provide information about one or more products or groups of products. For example, the interactive show can showcase wines from different regions or can include interviews with movie stars, critics' insights, movie recommendations, movie trailers, and movie trivia games all relating to a selected group of movies available on DVD.

The DVD can be played on a media player, such as DVD player or a DVD driver in a computer (e.g. PC). Alternatively, the content of the DVD can be provided via a web site or an electronic file. While playing the DVD, the media player displays an interactive catalog of services and products which can be purchased by redeeming funds identified by a an account identifier which can be in the form of a gift card provided with the DVD. A product or service can be ordered by placing an order over the phone, over the Internet, or by sending an e-mail. Alternatively, the products/service can be purchased in a retail store.

This system and method can provide a unique, viewer-guided “show” of information. A viewer may navigate through the show using innovative and interactive menus stored on the DVD. By using the menus, the viewer can adjust a variety of parameters involved in the playing of the show. For example, the viewer may change: the pace of the show, focus of the show, type and amount of the displayed information, and type and amount of interactions with the playing of the show. The control is easy and intuitive, and may be performed from a variety of interface input devices compatible with DVD players. Examples of such devices include DVD remote control, keyboard, and PDA. Alternatively, the show can be stored on a computer readable memory storage device and played on a computer.

### BRIEF DESCRIPTION OF THE DRAWINGS

The details of the present invention, both as to its structure and operation, may be gleaned in part by a study of the accompanying drawings, in which like reference numerals refer to like parts, and in which:

FIG. 1 is a block diagram illustrating exemplary modules stored on a digital data carrier;

FIG. 2 is a block diagram illustrating exemplary modules stored on the DVD;

FIG. 3 is a block diagram illustrating an example interactive transaction card and an interactive, viewer driven system for the playing of DVD modules;

FIG. 4 is a flow chart illustrating an example process for the initialization of a gift card system which includes a DVD;

FIG. 5 is a block diagram illustrating an example interactive transaction card and an interactive, viewer driven system for the playing of DVD modules;

FIG. 6 is a flow chart illustrating an example process for the playing of the DVD;

FIG. 7 is a flow chart illustrating an example process for the playing of one DVD module; and

FIG. 8 is a flow chart illustrating an example process for the playing of a sequence of DVD modules.

### DETAILED DESCRIPTION

Certain embodiments as disclosed herein provide for systems and methods for marketing and selling products or services utilizing a gift card system. For example, one method and system as disclosed herein includes a gift card system having a digital media carrier containing a variety of modules, including files with information the products being marketed. The products can be purchased by redeeming an account, which can be identified by a gift card that is provided with the digital media carrier. In one example, the modules include promotional material about movies The files can contain movie clips, movie reviews, movie trailers, interviews with movie starts and movie trivia. The files can also promote a variety of services, such as: video access service (e.g. “video on demand”), and video renting service (e.g. ordering rentals via an e-mail, phone, Internet (NetFlix®), etc.). Alternatively, the DVD can showcase other products such as, for example, wines from different regions, jewelry, and clothing. For ease of description, the products being marketed in the embodiments described below are often referred to as movies recorded on DVDs. However, the described systems and methods also apply to other products and services and the invention is not limited to marketing movies.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

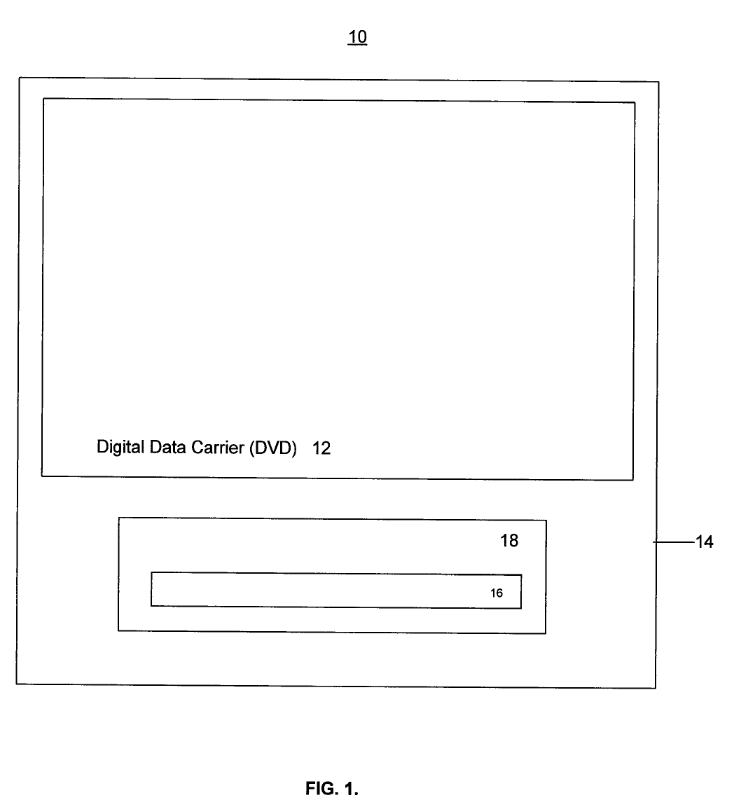

FIG. 1 is a block diagram of one embodiment of a gift card system 10. The terms gift card system and gift card are used interchangeably herein except when a gift card is being identified as a component of the gift card system. The system includes a DVD 12 In one embodiment the DVD 12 contains digital media which promotes the products being marketed. The DVD 12 is packaged with an account identifier 16. The account identifier corresponds to an account against which purchases can be charged or debited. The account identifier can be packaged with the DVD in a wide variety of forms. It can be a magnetic strip or a bar code on a gift card 18 with account identifying information represented on the magnetic strip. The gift card can be a section of a carrier 14 with perforations or score lines formed along the outer edges of the gift card 18 allowing for its separation from the carrier 14. Alternatively, it can be a separate card that is attached to the carrier 14 mechanically or with a releasable adhesive. In a further embodiment, the account identifier is printed or stamped on the carrier and/or on the DVD. Additionally, the account identifier can be printed on a label which is affixed to the DVD or the carrier. In one embodiment, the account identifier is sent electronically, for example via email, to the intended user. In this embodiment, the contents of the DVD 12 can instead be stored on and accessed as a web page or an electronic file that can be downloaded or attached to the email. Therefore, references to the contents and operation the DVD contained herein also apply to web pages and electronic files. The user intended user can be identified by an email address.

The carrier 14 can be formed from a wide range of materials within the scope of the present invention including, without limitation, plastic, nylon, polyvinyl chloride (PVC), cardboard stock, paper laminated with a plastic, and the like. The DVD can be attached to the carrier 14 in a variety of ways. For example, a releasable adhesive may be used or the carrier can include a releasable plastic fastener such as those typically included in DVD packages. The carrier can be in the form of a sheet or it can be folded to form a box or a simple folded cover like a greeting card with the DVD 12 attached within.

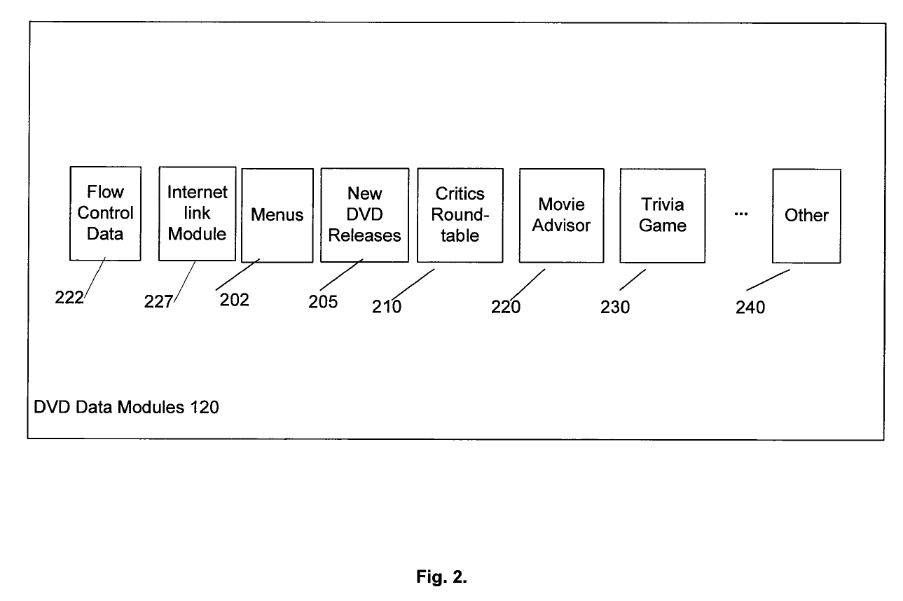

FIG. 2 further is a block diagram of the DVD 12 illustrating its functional components. In one embodiment the data stored on the DVD 12 contains flow control data 222 and internet link data 227. The flow control data 222 can be an auto-load module which contains information needed to initialize the reading of other modules from the DVD 12 by a DVD player. The flow control data 222 enables auto-loading of one or more modules stored on the DVD 12. Alternatively, it may load a link to an internet sight and cause the internet browser of the DVD player to launch and follow the link.

The when the media player is a device with the ability to connect to the Internet, the media player uses the Internet link module 227 to initiate an Internet connection, launch its own web browser, or invoke other browsers containing links to web sites comprising additional promotional information about products. Alternatively, the Internet link module can invoke an Internet browser on the media player and direct the browser to a site where the user can purchase the products (in this example movies on DVDs) using the account identifier.

The DVD 12 can also contain other modules or files which provide the content that can be displayed to the user. In one embodiment, the modules 124 and sub-modules 126 can contain menus and files or a combination of both. A menu is data which the media player processes to allow the user to input requests for the playing of the content of the DVD 12 on a multimedia display or to otherwise provide input. Examples of menus can include initial menus and secondary menus. A file is data which the media player processes and displays non-interactively. For example, in the embodiment wherein the gift card system is used to market movies on DVDs, the DVD can include content about movies on DVD.

In the embodiment depicted in FIG. 2, the DVD 12 includes a Menus module 202 which contains menus or an index of the contents of the DVD. The DVD can also include other content files such as new DVD releases 205, critics' round-table 210, movie advisor 220, a trivia game 230, or other promotional or informational data 240. The user can request the playing of any of these modules and/or their sub-modules by making an appropriate selection from one of the menus contained in the menu module 202. Alternatively, the media player can direct the user to these modules based on default sequences stored in the flow control module 222. As was mentioned above, this same result with the functions of the described modules can also be implement as a web page (or series of web pages) or an electronic file which can be stored on a server connected to a network including the Internet.

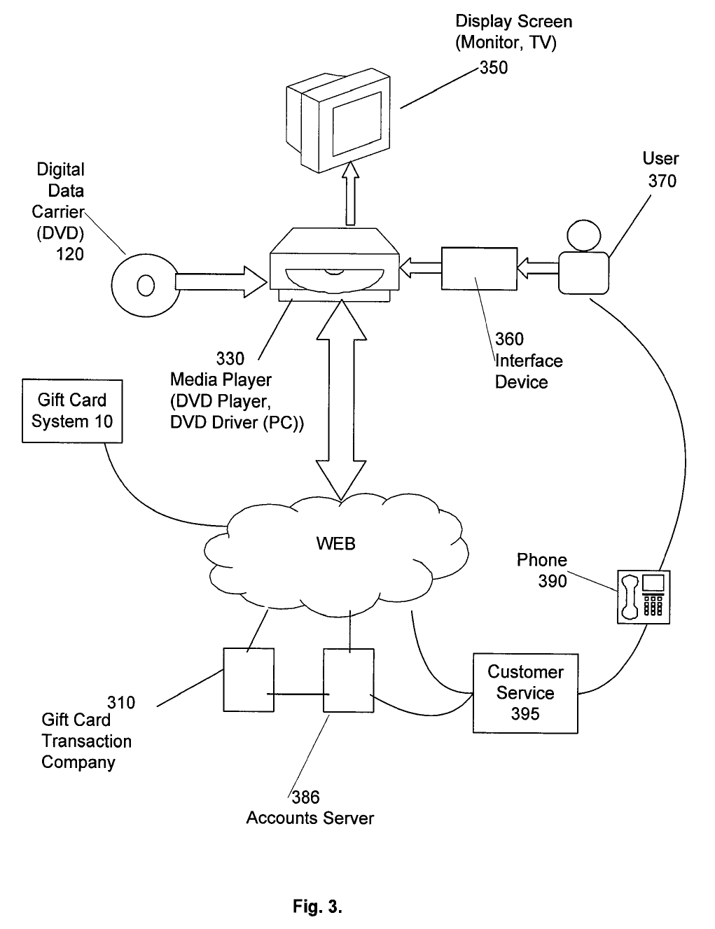

FIG. 3 is a graphical representation of an exemplary interactive, viewer driven system for the playing of DVD modules and interactive purchasing of products and/or services promoted by the DVD 12. In the illustrated embodiment, the gift card system 10, which includes a DVD 12 and an account identifier, are initialized or created by a gift card provider.

First, the gift card provider identifies products to be promoted by the gift card system and assigns face values to the gift card system. Then, the gift card provider collaborates with a gift card transaction company 310 which creates the appropriate accounts for the gift cards on an accounts server 380 which correspond to the account identifiers used with the gift card system. The account contains information and parameters specific for the gift card system offering. The parameters can contain, for example, a face value of the gift card offering and a field indicating whether the account has been activated. The account corresponding to an account identifier is typically activated at the time the gift card system is purchased (pre-paid) at a point of sale station such as a register in a store. An account identifier cannot be redeemed or utilized to make a purchase until it is activated.

The diagram in FIG. 3 also illustrates an example media player 330 accessing the DVD 12 and displaying the content of the DVD 12 on a display screen 350. Examples of the media players 330 can include a DVD player and computer DVD driver (for example, a component of a PC). Examples of the display screens 350 can include a television monitor or computer monitor with speakers.

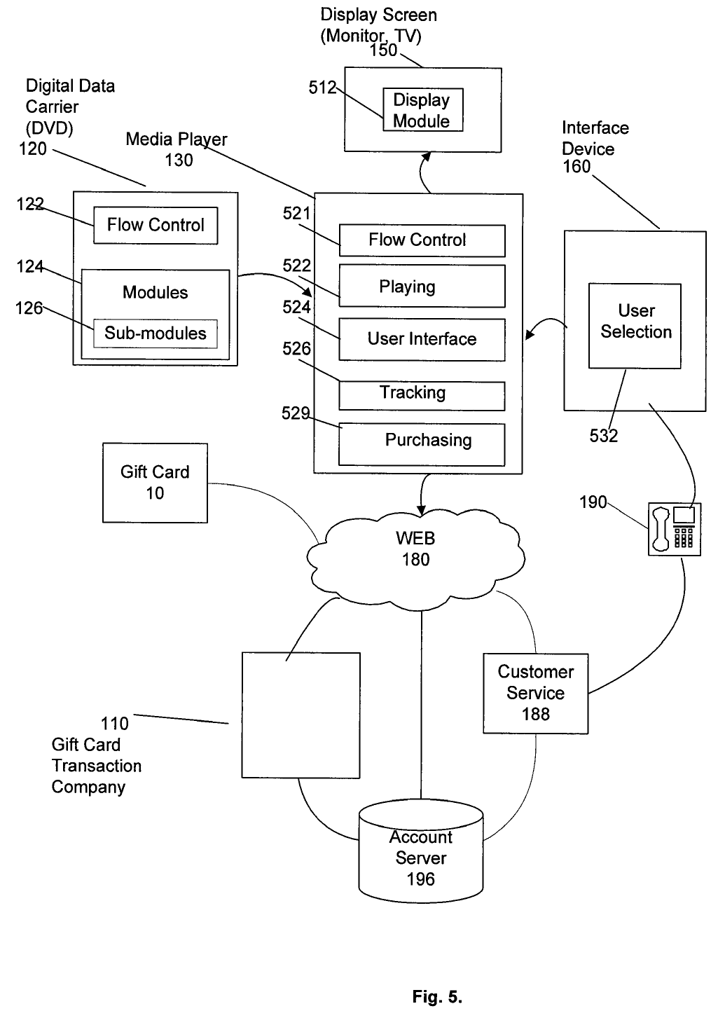

The media player 330 can access the flow control data 222, read the flow control data 222 from the DVD 12 and use it to display menus on the display screen 350 as will be described in more detail in connection with FIG. 5.

With continuing reference to FIG. 3, the media player 330 can also communicate with a user interface 360, which collects inputs from a user 370. The user interface device 360 and the media player 330 provide the user 370 with interactive capabilities, such as, for example, the ability to display menus, select a subsequent menu from the current menu, select a file from a menu, play a file, stop/pause/resume the playing of a file, return to a previous menu, and play a default sequence of files. Examples of the user interface device 360 can include a remote control device and a computer keyboard.

The interface device 360 passes inputs from the user 370 to the media player 330. After the media player 330 accesses an introductory menu from the flow control data 222 (described in FIG. 1), the display screen 350 displays the introductory menu. Then, the interface device 360 reads user inputs and passes them to the media player 330. After that, the media player 330 reads the user inputs and guides the user 370 to either a default sequence of DVD files, or to a particular DVD file.

In one embodiment the DVD contains an interactive catalog which the media player 330 can interactively display on the display screen 350. The interactive catalog can contain information promoting products and/or services. Also, the catalog can facilitate the purchase and access to the products. Examples of the products and services can include the purchasing (or renting) of movies, music and games and the purchasing of jewelry or wine.

The interactive catalog can also provide the user 370 with a telephone number 390 for a customer service system 395 which can be implemented as a call center using live operators or Voice Response Units (VRU), also known as Interactive Voice Response (IVR) or a combination of the two. The customer service system can also be a web server coupled to a network including the internet. The customer service system allows the customer to remotely purchase (purchasing without traveling to a store) the products in the catalogue using the account identifier. Alternatively, the catalog may provide a list of retail stores where the user 370 can purchase the products using the account identifier. Moreover, the catalog may provide the user 370 with information about a website from which the user 370 can order the products, or cable television site from which the user 370 can order, e.g., video on demand.

The media player 330 connected to a PC, or a media player which is Internet enabled, can use the Internet link module 227 from the DVD 12 to access a web site over the Internet, initialize the Internet browser and pass information and pages between the web site and the PC. From the Internet browser, the user 370 can purchase products or services (remotely purchase). Using the Internet, the user 370 can refer to the account identifier (e.g., stored on the gift card 10, or alternatively, on the DVD 12) to access the user account on the accounts server 380 to pay for the products and services.

In an embodiment wherein the account identifier is transmitted to the user electronically, the purchaser can select and purchase an account identifier for the user at a website hosted by, for example, the customer service system 395. The customer service system can then transmit an electronic message, for example, an email, to the user. The electronic message can include the account identifier and a link to the website having the content of the DVD which the user can then view in the manner described herein in connection with the DVD. Alternatively, the email can include an electronic file with the content of the DVD 12 or a link to a website from which the electronic file can be downloaded and played by the media player 330.

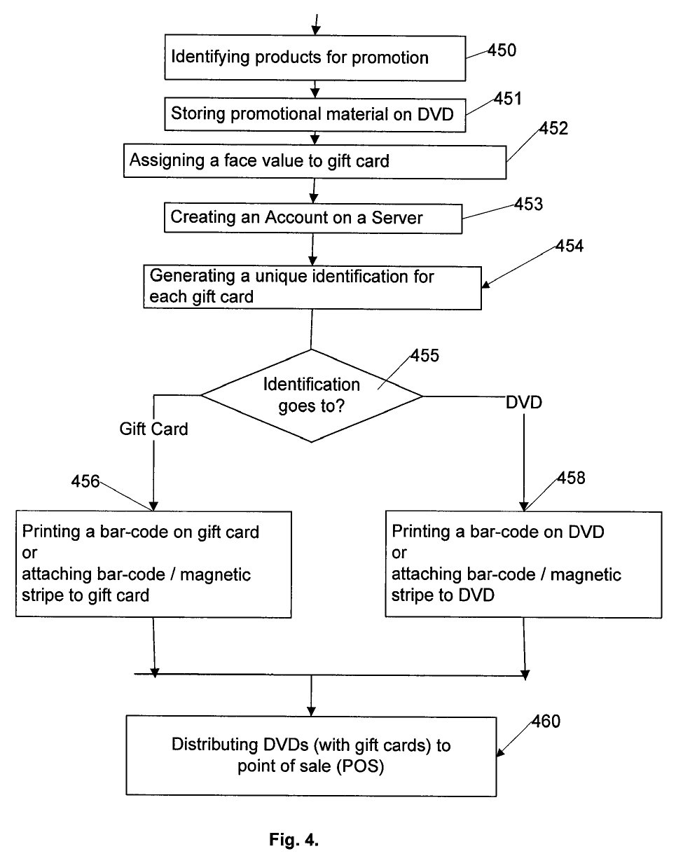

FIG. 4 is a flow chart illustrating an embodiment of the process for the initialization of the gift card system 10. In a step 450 a list of products and/or services (collectively referred to herein as products) to be marketed is identified, for example, by a gift card provider. After the products are identified, in a step 451 promotional materials for the products are created, they are stored or written in a digital format to one or more DVDs 12 (see FIG. 1) to be distributed as part of the gift card system 10. In one embodiment, included within the content of the DVD is information on how to redeem the gift card system in order obtain one or more of the products. For example a telephone number or web site address through which the gift card system can be redeemed. An embodiment of the format and operation of the promotional material is described in more detail below.

In a step 452, a face value is assigned to the gift card system. The face value can correspond to, for example, retail price of the gift card system and indicate the amount of funds that the consumer will be able to redeem while purchasing the promoted products with the gift card system. Alternatively, the value can be assigned at the time of purchase.

In a step 453, an account is created corresponding to each gift card system 10. In one embodiment the accounts are created on an accounts server and this step can be performed by a gift card transaction company (FIG. 3). The user account can be created for a specific group of products and limited to only purchases of those products. For example, an account can be created for action/adventure movie gift cards, or other types or groups of products. The account can also include specific parameters, such as the face value of the gift card, transaction rules, etc.

In a step 454, a unique number account identifier is created for each gift card. Each of the unique account identifiers corresponds an account created in step 453.

As represented by step 455, the account identifier can be stored and/or printed (generally, applied) on the gift card 18 or the carrier 14 (see FIG. 1). The account identifier can be applied in a variety of ways and in a variety of forms. For example, the account identifier can be applied as a bar code or stored in a magnetic strip or printed or contained in a label that is then applied to the gift card or the carrier.

In an alternative embodiment, in a step 458, the account identifier is applied to the DVD. The account identifier can be applied in a variety of ways and in a variety of forms. For example, the account identifier can be applied as a bar code or stored in a magnetic strip or printed or contained in a label that is then applied to the DVD. The account identifier can also be stored digitally as part of the content of the DVD. Alternatively, the account identifier can be transmitted electronically to the user, for example, via email.

In a step 460, the gift cards 10 are distributed to one or more points of sale (POS), such as retail stores, convenience stores, etc. When a gift card is purchased, the point of sale sends a message to the account server (see FIG. 3) which then activates the account corresponding to the account identifier of the purchased gift card. Alternatively, the account identifier can be purchased at a website and transmitted electronically to the user.

FIG. 5 is a block diagram of an example of the system modules of the interactive, viewer driven system for the playing of a DVD and for the purchasing of products and services promoted by the DVD. In the illustrated embodiment, the gift card system includes the DVD 12 and the gift card 18 which includes the account identifier. The system functions the same way if the account identifier is located on a gift card, a carrier, the DVD, or is transmitted to the user electronically. The DVD 12 and gift card 10 can be initialized and supplied by the gift card provider as it was described in connection with FIG. 4.

In one embodiment, after the DVD 12 is loaded into the media player 330, the media player 330 accesses the flow control data 222 from the DVD 12. Alternatively, the same content as is contained in the DVD 12 can be accessed via a website or from an electronic file. In general, the flow control data 222 provides the operating or instructions or flow sequence which are carried out by the flow control module 521 on the media player 330. The flow control module 521 selects the files and data for playing from DVD 12. Then, the play module 521 accesses those files from the DVD 12 and passes the content form the files to the display module 512, which displays them on the display screen 350. As shown in FIG. 5, the media player 330 provides the signals to the display screen 350 via the display module 512 of the display.

The flow control module 521 of the media player 330 selects modules 124 and sub-modules 126 of the DVD 12 for playing/displaying. To select a next module or sub-module, the media player 330 can utilize a sequence of selections made by a viewer in the past, a selection made by the viewer at the given moment, and a default sequence of modules and sub-modules stored on the DVD 12.

To facilitate communication between the media player 330 and the user, the flow control module 521 communicates with the user interface module 524 of the media player 330. The user interface 524 receives user inputs collected by a user selection module 532 of the interface device 360. The flow control module 521 uses the user inputs to facilitate the navigation through the contents of the DVD 12.

The flow control module 521 of the media player 330 parses the user input and determines whether to retrieve a new file or menu from the DVD 12, or to continue playing an already retrieved file. The flow control module 521 can also establish the sequence in which the files are played if the user provides no input. Moreover, the flow control module 521 can select (automatically or in response to user input) the purchasing module 529 which contains the information about purchasing of selected products or services. The purchasing module 529 contains data for the interactive catalog with products as described in FIG. 3.

One embodiment includes the tracking module 526. The tracking module 526 creates and maintains a tracking record of the sequence of DVD modules which are played by the media player 330, and creates a tracking record of user inputs. The flow control module 521 can use the tracking record created by the tracking module 526 when determining what file to play next.

When the media player is equipped with a network connection, the user may select to purchase a product promoted by the DVD 12 via the interface device 360. The flow control module 521 can invoke a browser using the data stored in the purchasing module 529. From the web browser, the user can access a customer service system 395, such as a website, and order a product or service. In one embodiment he content of the website the user is directed to is specific to the content of the DVD. For example, if the DVD is promoting a collection of classic movies available on DVD, the website is configured to allow easy purchasing of those promoted movies and would not present a larger or different collection of products. However, the website can allow the user to move to a different site with a different range of products.

To complete the transaction and pay for the product, the user utilizes the account identifier. The user can provide the account identifier to the customer service system 395, which in turn uses the account identifier to debit the associated account stored on the account server 380. As it was described in FIG. 3, the account contains information about the amount of funds available to the user. The customer service system 395 can deduct the value of the product from the funds on the user account to complete the transaction.

Alternatively, the user can contact the customer service system 395 by telephone 390. The phone contact instruction can be displayed by the flow control module 521. Using the phone, the user can purchase the product/service the same way as if he/she were using the customer service website. The user can also order the products using e-mail.

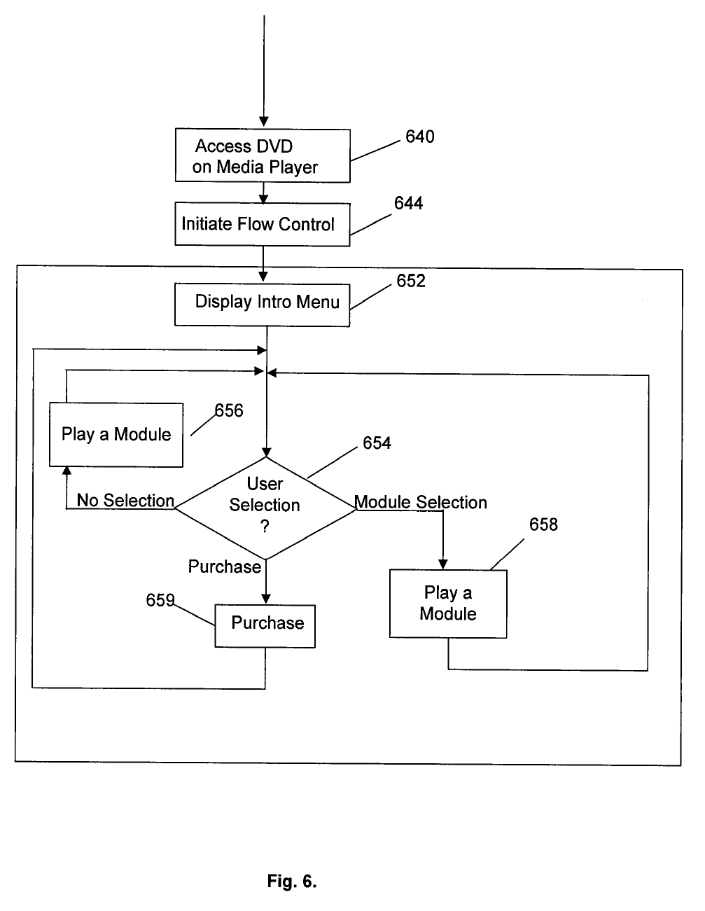

FIG. 6 is a high level flow chart illustrating a sequence of steps or processes performed when playing the DVD 12 in one embodiment of the present invention. In a first step 640, the media player accesses the content of the DVD. Accessing of the DVD begins with the reading of the flow control data from the DVD (FIG. 5). In a next step 644, the media player initializes the flow control module 521 (FIG. 5). Then, the flow control module initializes the playing module 522 (FIG. 5). In the step 652, the flow control module 521 (FIG. 5) selects an introductory menu to be played. Then, at the same step 652, the playing module 522 (FIG. 5) retrieves the introductory menu from the DVD and displays the menu on the display screen. The introductory menu can contain a list of options available to the user. At the step 654, the user can either make a selection from the menu (e.g., via the user interface 360 (FIG. 5)) or make no selection.

If the user makes no selection, then, at a step 656, the media player plays a default module. As it was described in connection with FIG. 5, the flow control module of the media player selects the next module based on the default sequence of modules (tracking record) stored on the DVD. However, the default sequence can vary according to the past selections (inputs) from the user and previously played modules (i.e. according to the tracking record of played modules). Once the playing of the default module is complete, at step 654, the flow control module checks again whether there is new user input. The flow control module can also continuously monitor for user input to allow a user to stop playing a module and return to the menu.

If the user makes a valid selection from the displayed introductory menu, then, at the step 654, the flow control module of the media player parses the user input, and determines whether the input is a valid purchase request, or whether the user input correlates to another module. If the user input is a purchase request, then, in a step 659, the flow control module invokes the purchasing module 529 (FIG. 2). If the user selected a module from the DVD, then, in a step 658, the flow control module (FIG. 5) accesses the selected module from the DVD. Then, in the same step 658, the playing module 522 (FIG. 5) retrieves the module from the DVD and displays it the display screen.

Once the playing of the default module, identified module, or purchase information is complete, at the step 654, the flow control module checks again whether there is new user input. In one embodiment, the user can select from a menu 202 (FIG. 2) the playing of just one module (or sub-module), or the playing of a sequence of modules (or sub-modules). If the user requests the playing of just one module, the flow control module 521 (as described in FIG. 5) selects only one file (or menu) for playing. For example, the playing of just one module is when the user requests from a menu the playing of just one movie clip, or just one subsequent menu. On the other hand, the playing of a sequence of modules is when the user requests from a menu the playing of a sequence of clips. In this case, the flow control module 521 (FIG. 5) selects no other menu until the playing of the sequence of modules is complete.

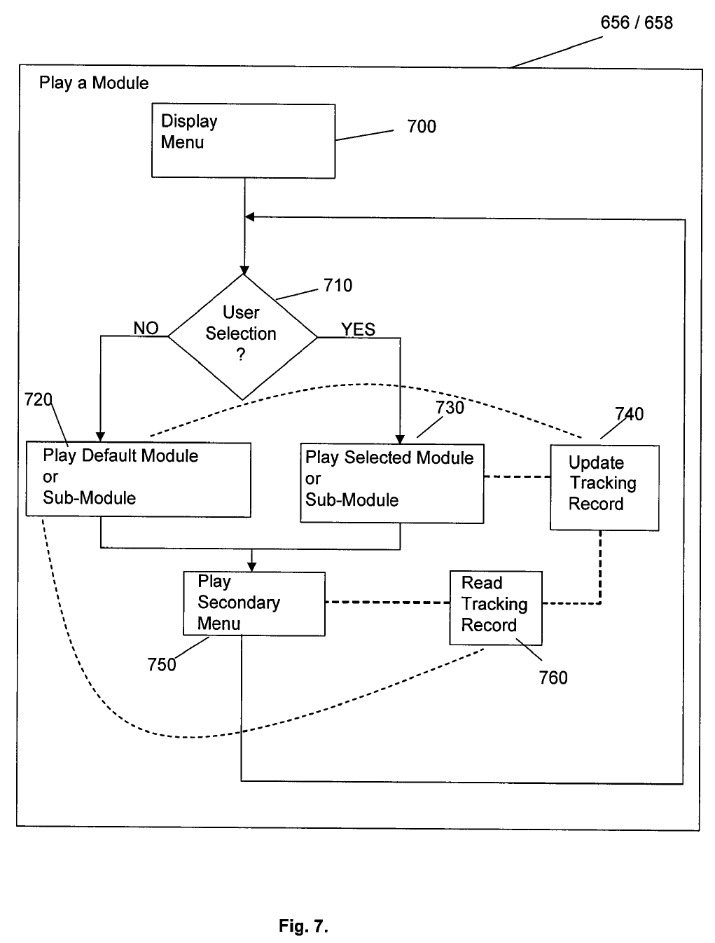

FIG. 7 is a flow chart illustrating details of the steps 656/658 of FIG. 6 in one embodiment. In a first step 700 the media player displays a menu which contains selection options available to the user. The user can either make a selection from the menu or can let the flow control module 521 (FIG. 5) select which DVD module will be played next (default).

If the user makes no selection, then, in a step 720, the media player plays a default module or sub-module. In the step 720, the flow control module 521 of the media player selects the next DVD module based on a default sequence of modules stored on the DVD, or, if there is a tracking record of user selections, the flow control module can read the tracking record in a sub-step 760 and use that information in determining the default module or sub-module according to the flow control data 222sss. While performing the step 720, the tracking module 526 (FIG. 5) updates the tracking record in a sub-step 740. Then, the playing module 522 (FIG. 5) of the media player plays the identified module or sub-module. Once the playing of the default module is complete, the flow control module of the media player proceeds to a step 750, and plays a secondary menu, which will be described below.

If the user makes a valid selection from the introductory menu, in a step 730, the media player plays the selected module or sub-module from the DVD. While performing the step 730, the tracking module 526 reads the tracking record in the sub-step 760 and updates the tracking record in the sub-step 740. Then, the playing module 522 (FIG. 5) of the media player plays the selected module or sub-module. Once the playing of the selected module (or sub-module) is complete, the flow control module of the media player proceeds to a step 750 to select a secondary menu. Once the flow control module selects the secondary menu, the playing module 522 (FIG. 5) of the media player plays it on the display screen. Then, the user can either make a selection from the secondary menu or can let the flow control module select which DVD module will be played next.

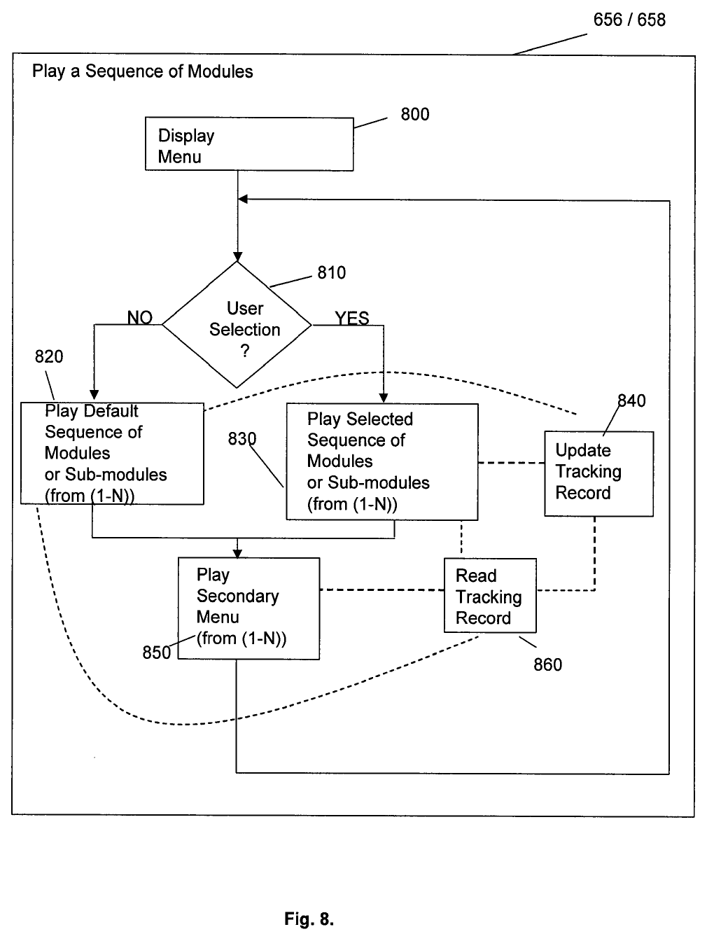

FIG. 8 is a flow chart illustrating details of steps 656/658 of FIG. 6 involved in the playing of a sequence of DVD modules in one embodiment. In a first step 800, the flow control module 521 of the media player displays a menu, which contains selection options available to the user. The user can either make a selection from the menu or can let the flow control module 521 select which sequence of DVD modules will be played next.

If the user makes no selection, then, in a step 820, the media player plays one of “N” default sequences of modules or sub-modules. In the step 820, the flow control module 521 (FIG. 5) of the media player selects the next sequence of DVD modules based on a default sequence of modules stored on the DVD, or, if there is a tracking record of user selections, the flow control module can read the tracking record in a sub-step 860 and use that information in determining the default sequence of modules or sub-modules. While performing the step 820, the tracking module 526 (FIG. 5) updates the tracking record in a sub-step 840. Then, the playing module 522 (FIG. 5) of the media player plays the identified sequence of modules or sub-modules. Once the playing of the default sequence of modules (or sub-modules) is complete, the flow control module of the media player proceeds to a step 850, and plays a secondary menu, which will be described below.

If the user makes a valid selection from the introductory menu, in a step 830, the media player plays the selected sequence of modules or sub-modules from the DVD. The valid selection indicates one of the “N” sequences of modules or sub-modules. While performing the step 830, the tracking module 526 (FIG. 5) reads the tracking record in the sub-step 860 and updates the tracking record in the sub-step 840. Then, the playing module 522 of the media player plays the selected sequence of modules or sub-modules. Once the playing of the selected sequence of modules (or sub-modules) is complete, the flow control module of the media player proceeds to a step 850 to select one of “N” secondary menus. Once the flow control module 521 selects the secondary menu, the playing module 522 (FIG. 5) of the media player plays it on the display screen. Then, the user can either make a selection from the secondary menu or can let the flow control module select which sequence of DVD modules will be played next.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill will further appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit without departing from the invention.

Moreover, the various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

While the particular system and method herein shown and described in detail is fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for making a multi media gift card, the method comprising:
identifying products to be marketed;
creating promotional materials for the identified products;
storing a copy of the promotional materials in a digital form on a plurality of digital data carriers;
creating a plurality of accounts on an account server and creating an account identifier for each account; and
packaging each of the plurality of digital data carriers with one of the plurality of account identifiers.

2. The method of claim 1, further comprising storing on each of the plurality of digital data carriers information on how to remotely purchase one or more of the identified products using the account identifier.

3. The method of claim 1 wherein each account has an associated value.

4. The method of claim 1 wherein the account identifiers are packaged with the digital data carriers as a bar code.

5. The method of claim 1 wherein the account identifiers are packaged with the digital data carriers as a magnetic strip.

6. The method of claim 1 wherein the account identifiers are packaged with the digital data carriers as a label.

7. The method of claim 1 wherein the account identifiers are packaged with the digital data carriers as at card.

8. The method of claim 1 further comprising providing a gift card including the account identifier.

9. A gift card system for the purchasing of selected products, the system comprising:
an account identifier;
a carrier; and
a digital data carrier attached to the carrier and storing instructions that, when executed by a media player, cause the media player to perform a method comprising
retrieving and displaying an introductory menu displaying playing options to a user,
receiving user input indicative of a user selection,
retrieving and displaying one of a plurality of content modules stored on the digital data carrier corresponding to the user selection, wherein the content modules have information relating to one or more of the selected products.

10. The system of claim 9 wherein the digital data carrier further comprises at least one purchasing module which contains information about purchasing the selected products using the account identifier.

11. The system of claim 10 wherein the digital data carrier further comprises a tracking module storing instructions that, when executed by a media player, cause the media player to perform a method comprising:
creating and updating a tracking record of the sequence of the content modules which have been displayed by the media player; and
creating and updating a record of user inputs.

12. A method for promoting products using a gift card system, the method comprising:
selecting products to be marketed;
creating promotional materials for the identified products;
storing a copy of the promotional materials and remote purchasing information on a plurality of digital data carriers;
creating a plurality of account identifiers;
packaging each of the plurality of digital data carriers with one of the plurality of account identifiers; and
remotely purchasing one or more of the selected products using the account identifier.

13. The method of claim 12 further comprising creating an account on an account server for each of the plurality of account identifiers.

14. The method of claim 13 wherein each account has an associated value.

15. The method of claim 12 wherein the account identifiers are packaged with the digital data carriers as a bar code.

16. The method of claim 12 wherein the account identifiers are packaged with the digital data carriers as a magnetic strip.

17. The method of claim 12 wherein the account identifiers are packaged with the digital data carriers as a label.

18. The method of claim 12 wherein the account identifiers are packaged with the digital data carriers as at card.

19. The method of claim 12 further comprising providing a gift card including the account identifier.

20. A method for promoting and purchasing products using a pre-paid making a multi media gift card, the method comprising:
identifying products to be marketed;
creating promotional materials for the identified products;
storing a copy of the promotional materials in a digital form;
creating a plurality of accounts on an account server and creating an account identifier for each account;
receiving payment for an account identifier and identifying the user;
electronically transmitting the account identifier to the user; and
electronically providing the user with access to the promotional materials.

21. The method of claim 20 wherein electronically transmitting the account identifier to the user comprises transmitting an email to the user.

22. The method of claim 20 wherein identifying the user comprises receiving an email address for the user.

23. The method of claim 20 further comprising assigning a value to an account.
